(19) United States
(12) Patent Application Publication
(10) Pub. No.: US 2024/0164541 A1
(43) Pub. Date: May 23, 2024

(54) SPONGE CORE

(71) Applicant: GUANGDONG SWEETNIGHT HOME CO., LTD., Foshan (CN)

(72) Inventors: Shuimu HUANG, Maoming (CN); Runlan REN, Huizhou (CN)

(21) Appl. No.: 18/329,918

(22) Filed: Jun. 6, 2023

(30) Foreign Application Priority Data
Nov. 19, 2022 (CN) 202223068547.4

(51) Int. Cl. A47C 27/14; A47C 27/00; A47C 27/15; B32B 3/26; B32B 5/18; B32B 5/32; B32B 7/02

(52) U.S. Cl. CPC A47C 27/148; A47C 27/002; A47C 27/146; A47C 27/15; B32B 3/263; B32B 3/266; B32B 5/18; B32B 5/32; B32B 7/02; B32B 2307/72; B32B 2479/00

(57) ABSTRACT

A sponge core relates to a technical field of mattresses and includes a mattress and a mattress cover. The mattress includes a first sponge core, a second sponge core, a third sponge core, and a fourth sponge core. A density of the first sponge core, a density of the second sponge core, a density of the third sponge core, and a density of the fourth sponge core are different from each other. The mattress cover is wrapped on a surface of the mattress, the mattress cover includes a front wrapping layer, a rear wrapping layer, a left wrapping layer, a right wrapping layer, a front end wrapping layer, and a rear end wrapping layer, the front wrapping layer is laid on the fourth sponge core, the left wrapping layer and the right wrapping layer are respectively sewn and connected to two sides of the front wrapping layer

### TECHNICAL FIELD

The present disclosure relates to a technical field of mattresses, in particular to a sponge core bringing four body sensations and made by specific-shaped cutting.

### BACKGROUND

Generally, an internal structure of a mattress may be made up of a plurality of springs arranged side by side with same specification or the internal structure of the mattress is made up of spongy fillers.

For example, the Chinese patent application No. CN201320616944.2, with an application date of Oct. 8, 2013, titled “mattress”, discloses a mattress, which relates to a field of daily necessities. The mattress includes a top layer, a filling layer and a supporting portion. The top layer is wrapped around an outer side of the supporting portion, and the filling layer is arranged between the top layer and the supporting portion. The supporting portion includes three parts, such as a plurality of outer springs, a plurality of inner springs, and a porous flat hard cotton layer. The plurality of inner springs are arranged in parallel, the plurality of outer springs are symmetrically arranged on two sides of the plurality of internal springs, and the porous flat hard cotton layer is wrapped on outer sides of the plurality of outer springs and the plurality of inner springs. When a user sits on the mattress, the user does not notice that springs are arranged in a circumference of the mattress which improves a comfort of the mattress.

However, the above patent has following shortcomings. Since a softness of the mattress cannot be adjusted according to the user's sleep habits, the user's sleep quality is reduced.

### SUMMARY

Problems to be solved by the present disclosure are to overcome the shortcomings of the prior art. The present disclosure aims to provide a sponge core bringing four body sensations and made by specific-shaped cutting, which solves or at least partially solves the problems.

In order to solve the above problems, the technical solutions of the present disclosure are as follows.

The sponge core bringing four body sensations and made by specific-shaped cutting includes a mattress and a mattress cover. The mattress includes a first sponge core, a second sponge core, a third sponge core, and a fourth sponge core. A density of the first sponge core, a density of the second sponge core, a density of the third sponge core, and a density of the fourth sponge core are different from each other. The mattress cover is wrapped on a surface of the mattress. The mattress cover includes a front wrapping layer, a rear wrapping layer, a left wrapping layer, a right wrapping layer, a front end wrapping layer, and a rear end wrapping layer. The front wrapping layer is laid on the fourth sponge core. The left wrapping layer and the right wrapping layer are respectively sewn and connected to two sides of the front wrapping layer. The front end wrapping layer is sewn and connected to a top of the front wrapping layer. The rear wrapping layer is laid on a surface of the first sponge core. The rear wrapping layer is sewn and connected to the left wrapping layer, the right wrapping layer, and the front end wrapping layer. The rear end wrapping layer is sewn and connected to the rear wrapping layer. The rear end wrapping layer is detachably connected to the left wrapping layer, the front wrapping layer, and the right wrapping layer. In the present disclosure, the rear end wrapping layer is detachably connected to the left wrapping layer, the front wrapping layer, and the right wrapping layer, so it is convenient to adjust a stacking order of the first sponge core, the second sponge core, the third sponge core and the fourth sponge core.

Optionally, the first sponge core, the second sponge core, the third sponge core, and the fourth sponge core are all made by special-shaped cutting.

Optionally, in order to facilitate the disassembly and installation of the rear end wrapping layer, the rear end wrapping layer is detachably connected to the left wrapping layer, the front wrapping layer, and the right wrapping layer through a zipper.

Furthermore, in order to increase the breathability of the mattress, the first sponge core, the second sponge core, the third sponge core, and the fourth sponge core define groups of breathable holes, and each of the groups of the breathable holes are arranged at equal intervals.

Furthermore, the density of the first sponge core is greater than the density of the second sponge core. The density of the second sponge core is greater than the density of the third sponge core. The density of the third sponge core is greater than the density of the fourth sponge core.

Optionally, in order to increase the comfort and breathability of the mattress cover, the front wrapping layer, the rear wrapping layer, the left wrapping layer, the right wrapping layer, the front end wrapping layer, and the rear end wrapping layer are made of cotton cloth.

The higher a density of a sponge, the heavier the sponge, the smaller pores inside the sponge, and the harder the sponge. Compared with the prior art, in the present disclosure, the mattress comprises four sponge cores with different densities and by adjusting the stacking order of the first sponge core, the second sponge core, the third sponge core and the fourth sponge core, the sponge core is able to bring four different body sensations to the user when the user sleeps on the mattress.

The specific embodiments of the present disclosure will be further described in detail below in conjunction with the accompanying drawings.

### BRIEF DESCRIPTION OF DRAWINGS

As a part of the present disclosure, the drawings are used to provide a further understanding of the present disclosure. The embodiments and the explanations of present disclosure are used to explain the present disclosure, but do not constitute an improper limitation of the present disclosure. The drawings in the following description are only some embodiments, and for ordinary technical personnel in the field, other drawings can be obtained based on these drawings without any creative labor.

In the drawings:

FIG. 1 is a cross-sectional schematic diagram of a sponge core bringing four body sensations and made by specific-shaped cutting according to one embodiment of the present disclosure.

FIG. 2 is a front side schematic diagram of the sponge core according to one embodiment of the present disclosure.

FIG. 3 is a structural schematic diagram of a mattress of the sponge core according to one embodiment of the present disclosure.

FIG. 4 is a structural schematic diagram of a mattress cover of the sponge core according to one embodiment of the present disclosure.

Numerals in the drawings: 1. mattress cover; 101. front wrapping layer; 102. rear wrapping layer; 103. left wrapping layer; 104. right wrapping layer; 105. front end wrapping layer; 106. rear end wrapping layer; 2. zipper; 3. mattress; 301. first sponge core; 302. second sponge core; 303. third sponge core; 304. fourth sponge core; 4. breathable hole.

It should be noted that these figures and textual descriptions are not intended to limit the conceptual scope of the present disclosure in any way, but rather to illustrate the concept of the present disclosure for those skilled in the art by referring to the embodiments.

### DETAILED DESCRIPTION

In order to make the purpose, technical solutions and advantages of the embodiments of the present disclosure more clearly, the following will provide a clear and complete description of the technical solution in the embodiments in conjunction with the drawings in the embodiments of the present disclosure, and the following embodiments are used to illustrate the present disclosure but do not limit the scope of the present disclosure.

### Embodiment 1

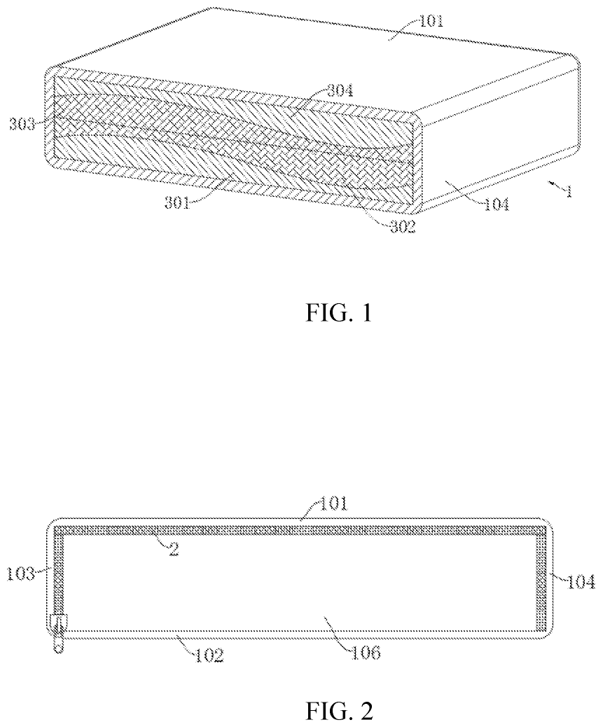

Referring to FIGS. 1 to 4, the present disclosure provides a sponge core bringing four body sensations and made by specific-shaped cutting. The sponge core includes a mattress 3 and a mattress cover 1. The mattress 3 includes a first sponge core 301, a second sponge core 302, a third sponge core 303, and a fourth sponge core 304. A density of the first sponge core 301, a density of the second sponge core 302, a density of the third sponge core 303, and a density of the fourth sponge core 304 are different from each other. The mattress cover 1 is wrapped on a surface of the mattress 3, and the mattress cover 1 includes a front wrapping layer 101, a rear wrapping layer 102, a left wrapping layer 103, a right wrapping layer 104, a front end wrapping layer 105, and a rear end wrapping layer 106. The front wrapping layer 101 is laid on the fourth sponge core 304, the left wrapping layer 103 and the right wrapping layer 104 are respectively sewn and connected to a left side and a right side of the front wrapping layer 101. The front end wrapping layer 105 is sewn and connected to a top of the front wrapping layer 101. The rear wrapping layer 102 is laid on a surface of the first sponge core 301, The rear wrapping layer 102 is sewn and connected to the left wrapping layer 103, the right wrapping layer 104, and the front end wrapping layer 105. The rear end wrapping layer 106 is sewn and connected to the rear wrapping layer 102. The rear end wrapping layer 106 is detachably connected to the left wrapping layer 103, the front wrapping layer 101, and the right wrapping layer 104. In the present disclosure, the rear end wrapping layer is detachably connected to the left wrapping layer, the front wrapping layer, and the right wrapping layer, so it is convenient to adjust a stacking order of the first sponge core, the second sponge core, the third sponge core and the fourth sponge core.

The first sponge core 301, the second sponge core 302, the third sponge core 303, and the fourth sponge core 304 are all made by special-shaped cutting.

The rear end wrapping layer 106 is detachably connected to the left wrapping layer 103, the front wrapping layer 101, and the right wrapping layer 104 through a zipper 2.

A density of the first sponge core 301 is greater than a density of the second sponge core 302. The density of the second sponge core 302 is greater than a density of the third sponge core 303. The density of the third sponge core 303 is greater than a density of the fourth sponge core 304.

When in use, the higher a density of a sponge, the heavier the sponge, the smaller pores inside the sponge, and the harder the sponge. For example, the sponge weighing 8 kilograms has a volume of one cubic meter, if two cubic meters of the sponge weighing 16 kilograms are compressed into one cubic meter, then a density of the sponge is 16. If three cubic meters of the sponge are compressed into one cubic meter, the density of the sponge becomes 24. It can be inferred that the higher the density of the sponge, the harder it becomes. Therefore, the density of the first sponge core 301 is greater than the density of the second sponge core 302, the density of the second sponge core 302 is greater than the density of the third sponge core 303, and the density of the third sponge core 303 is greater than the density of the fourth sponge core 304, which represents that the first sponge core 301 is hard, the second sponge core 302 is medium hard, the third sponge core 303 is medium soft, and the fourth sponge core 304 is soft. When a user lies on the mattress 3 and the first sponge core 301, the second sponge core 302, the third sponge core 303, and the fourth sponge core 304 are sequentially arranged on a lower side of the front wrapping layer 101, the sponge core brings a specific sleep sensation for the user.

When it is necessary to replace a stacking order of the first sponge core 301, the second sponge core 302, the third sponge core 303, and the fourth sponge core 304, the user may open the mattress cover 1 through the zipper 2, and the rear end wrapping layer 106 is opened from one side so that one end of the first sponge core 301, one end of the second sponge core 302, one end of the third sponge core 303 and one end of the fourth sponge core 304 are exposed. Then the user may extract one of the first sponge core 301, the second sponge core 302, the third sponge core 303, and the fourth sponge core 304 according to a sleep habit of the user. The extracted sponge core is placed inside the mattress cover 1, is arranged above other three sponge cores, and is in contact with the lower side of the front wrapping layer 101. Finally, the zipper 2 is zipped. Since the first sponge core 301, the second sponge core 302, the third sponge core 303, and the fourth sponge core 304 are made by special-shaped cutting, fit of the contact surfaces of the first sponge core 301, the second sponge core 302, the third sponge core 303, and the fourth sponge core 304 are increased, thereby improving the support effect of the mattress 3.

### Embodiment 2

Referring to FIG. 1 and FIG. 4, the sponge core provided in the embodiment 2 is basically the same as the sponge core of the embodiment 1. Furthermore, in the embodiment, the front wrapping layer 101, the rear wrapping layer 102, the left wrapping layer 103, the right wrapping layer 104, the front end wrapping layer 105, and the rear end wrapping layer 106 are made of cotton cloth. When the user is sleeping, the body skin of the user directly contacts the mattress cover 1 wrapped around the mattress 3. The mattress cover 1 is made of the cotton cloth, and the cotton cloth has good breathability and comfort, thereby increasing the comfort of the user when sleeping.

### Embodiment 3

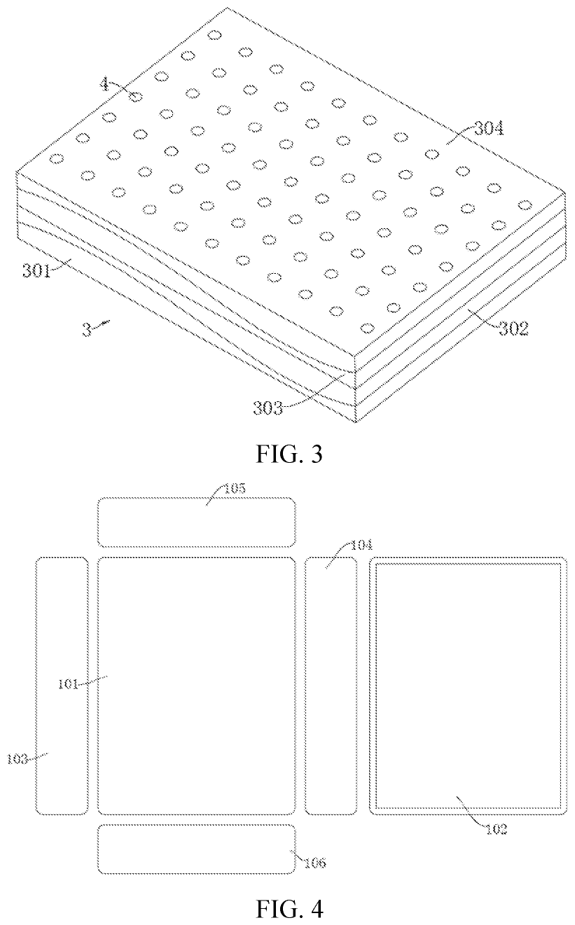

Referring to FIG. 3, the sponge core provided in the embodiment 3 is basically the same as the sponge core of the embodiment 1. Furthermore, the first sponge core 301, the second sponge core 302, the third sponge core 303, and the fourth sponge core 304 define groups of breathable holes 4. The groups of the breathable holes 4 are arranged at equal intervals.

In the embodiment, the groups of the breathable holes 4 are arranged at the equal intervals, and the mattress cover 1 is made of the cotton cloth with good breathability. Compared with a conventional sponge core with poor breathability the sponge core of the embodiment increases the breathability of the mattress 3, and effectively prevents the mattress 3 from being moldy and rotted when in contact with sweat excreted by the body.

The description explains a large number of specific details. It can be understood that the embodiments of the present disclosure can be practiced without these specific details. In some embodiments, the well-known methods, the structures, and the techniques are not shown in detail to avoid blurring the understanding of the description.

The above description is merely embodiment of the present disclosure and does not impose any formal limitations on the present disclosure, Although the present disclosure is disclosed in preferred embodiments, it is not intended to limit the present disclosure, any technical personnel familiar with the present disclosure, without departing from the scope of the technical solution of the present disclosure, can make some changes or modify equivalent embodiments by utilizing the technical content mentioned above, any simple modifications, equivalent changes, or modifications made to the above embodiments based on the technical solution of the present disclosure, which are not separated from the technical solution of the present disclosure, shall still fall within the scope of the present disclosure.

What is claimed is:

1. A sponge core, comprising:
a mattress (3), and
a mattress cover (1);
wherein the mattress (3) comprises a first sponge core (301), a second sponge core (302), a third sponge core (303), and a fourth sponge core (304), a density of the first sponge core (301), a density of the second sponge core (302), a density of the third sponge core (303), and a density of the fourth sponge core (304) are different from each other; the mattress cover is wrapped on a surface of the mattress (3);
wherein the mattress cover (1) comprises a front wrapping layer (101), a rear wrapping layer (102), a left wrapping layer (103), a right wrapping layer (104), a front end wrapping layer (105), and a rear end wrapping layer (106); the front wrapping layer (101) is laid on the fourth sponge core (304); the left wrapping layer (103) and the right wrapping layer (104) are respectively sewn and connected to two sides of the front wrapping layer (101; the front end wrapping layer (105) is sewn and connected to a top of the front wrapping layer (101); the rear wrapping layer (102) is laid on a surface of the first sponge core (301); the rear wrapping layer (102) is sewn and connected to the left wrapping layer (103), the right wrapping layer (104), and the front end wrapping layer (105); the rear end wrapping layer (106) is sewn and connected to the rear wrapping layer (102); and the rear end wrapping layer (106) is detachably connected to the left wrapping layer (103), the front wrapping layer (101), and the right wrapping layer (104).

2. The sponge core according to claim 1, wherein the first sponge core (301), the second sponge core (302), the third sponge core (303), and the fourth sponge core (304) are made by special-shaped cutting.

3. The sponge core according to claim 1, wherein the rear end wrapping layer (106) is detachably connected to the left wrapping layer (103), the front wrapping layer (101), and the right wrapping layer (104) through a zipper (2).

4. The sponge core according to claim 2, wherein the first sponge core (301), the second sponge core (302), the third sponge core (303), and the fourth sponge core (304) define groups of breathable holes (4), each of the groups of breathable holes (4) are arranged at equal intervals.

5. The sponge core according to claim 4, wherein the density of the first sponge core (301) is greater than the density of the second sponge core (302); the density of the second sponge core (302) is greater than the density of the third sponge core (303); and the density of the third sponge core (303) is greater than the density of the fourth sponge core (304).

6. The sponge core according to claim 1, wherein the front wrapping layer (101), the rear wrapping layer (102), the left wrapping layer (103), the right wrapping layer (104), the front end wrapping layer (105), and the rear end wrapping layer (106) are made of cotton cloth.
